(19) United States
(12) Patent Application Publication
(10) Pub. No.: US 2021/0232810 A1
(43) Pub. Date: Jul. 29, 2021

(54) AUTOMATED MONITORING SYSTEM FOR BIOMECHANICAL POSTURAL ASSESSMENT

(71) Applicant: University of Washington, Seattle, WA (US)

(72) Inventors: Behnoosh Parsa, Seattle, WA (US); Ashis G. Banerjee, Seattle, WA (US)

(73) Assignee: University of Washington, Seattle, WA (US)

(21) Appl. No.: 17/155,988

(22) Filed: Jan. 22, 2021

Related U.S. Application Data
(60) Provisional application No. 62/965,665, filed on Jan. 24, 2020.

(51) Int. Cl. G06K 9/00; G06N 3/08; G06N 3/04; G06T 7/73; G06K 9/62

(52) U.S. Cl. CPC G06K 9/00335; G06N 3/08; G06N 3/049; G06N 3/0445; G06N 3/0454; G06T 2207/20084; G06K 9/6256; G06T 2207/10016; G06T 2207/30196; G06T 2207/20081; G06T 7/73

(57) ABSTRACT

In some embodiments, a system is provided that comprises a computing system including at least one computing device and a camera communicatively coupled to the computing system via a network. The computing system is configured to generate a set of features based on three-dimensional joint location data representing postures of a subject over a plurality of time steps depicted in video data captured by the camera; provide the set of features to a first machine learning model trained to identify a start time step, an end time step, and an action identity for each action; provide the set of features to a second machine learning model trained to determine a postural assessment score for each time step; and determine an action score for each action based on the start time steps, the end time steps, the action identities, and the postural assessment scores for each time step.

### CROSS-REFERENCE(S) TO RELATED APPLICATION(S)

This application claims the benefit of Provisional Application No. 62/965,665, filed Jan. 24, 2020, the entire disclosure of which is hereby incorporated by reference herein for all purposes.

### BACKGROUND

With the advancements in computer vision techniques, automated Human Action Evaluation (HAE) has received significant attention. The aim of this category of problems is to design a computational model that captures the dynamic changes in human movement and measures the quality of human actions based on a predefined metric. HAE has been studied in a variety of computer vision applications such as sports activity scoring, athletes training, rehabilitation and healthcare, interactive games, skill assessment, and workers activity assessment in industrial settings. Some of the earlier works on HAE used traditional feature extraction methods for performance analysis.

Recently, with the popularity of deep learning methods, a multitude of creative solutions have emerged for solving HAE problems. Among the proposed methods, some directly learn a mapping from images to a quality score. As the action quality is highly task-dependent a majority of research is focused on leveraging the available action information in the learning process. Another approach has been to measure the deviation of a test sequence from a template sequence for determining the action quality. This approach is valuable when the performance of humans is evaluated based on how well they followed a fixed series of activities in a certain way such as in sport competitions or manufacturing operations.

There is another aspect of HAE that has received less attention despite its importance and potential impact on the safety and health of the society. Human Postural Assessment (HPA) is studied in various fields such as biomechanics, physiotherapy, neuroscience, and more recently in computer vision. HPA is a subcategory of HAE that focuses on determining the quality of human posture using a ergonomics-based (or biomechanics-based) criteria. There are three major challenges in solving HPA problems: (1) the type of task and the object involved in the activity highly influence the risk level. (2) The repetition of certain movements can cause accumulated pressure on specific body parts. Therefore, it is important to analyze a video in a frame-wise fashion to be able to capture repetition. (3) Everyone does not necessarily perform a task in the same way, hence, a successful analysis technique should learn the relation between human joints dynamics and the corresponding ergonomics risk score.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a system is provided that comprises a computing system including at least one computing device. The system also includes a camera communicatively coupled to the computing system via a network. The computing system is configured to generate a set of features based on three-dimensional joint location data representing postures of a subject over a plurality of time steps depicted in video data captured by the camera, provide the set of features to a first machine learning model trained to identify a start time step, an end time step, and an action identity for each action of the plurality of actions, provide the set of features to a second machine learning model trained to determine a postural assessment score for each time step, and determine an action score for each action of the plurality of actions based on the start time steps, the end time steps, the action identities, and the postural assessment scores for each time step.

In some embodiments, a computer-implemented method of providing biomechanical analyses of movements of a subject is provided. A computing device generates a set of features based on three-dimensional joint location data representing positions of the subject over a plurality of time steps while performing a plurality of actions. The computing device provides the set of features to a first machine learning model trained to identify a start time step, an end time step, and an action identity for each action of the plurality of actions. The computing device provides the set of features to a second machine learning model trained to determine a postural assessment score for each time step. The computing device determines an action score for each action of the plurality of actions based on the start time steps, the end time steps, the action identities, and the postural assessment scores for each time step.

In some embodiments, a computer-implemented method of training machine learning models to provide biomechanical analyses of movements of subjects is provided. A computing device receives a set of training data, where each instance of training data in the set of training data is labeled with a plurality of activities that each take place over a series of time steps, and each activity of the plurality of activities is labeled with a postural assessment score. The computing device generates features for each instance of training data. The computing device trains a first machine learning model to accept features of an instance of training data as input and to provide a plurality of action identities, start time steps, and end time steps as output. The computing device trains a second machine learning model to accept features of an instance of training data as input and to provide a postural assessment score as output for each time step. The computing device stores the first machine learning model and the second machine learning model in a model data store for processing new data.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic illustration of a non-limiting example embodiment of a system for automated monitoring of biomechanical postural assessment according to various aspects of the present disclosure.

FIG. 2 is a block diagram that illustrates a non-limiting example embodiment of a biometric analysis computing device according to various aspects of the present disclosure.

FIG. 3 is a flowchart that illustrates a non-limiting example embodiment of a method of training machine learning models to provide biomechanical analyses of movements of subjects according to various aspects of the present disclosure.

FIG. 4 is a schematic drawing that illustrates a non-limiting example embodiment of a backbone for spatial feature extraction according to various aspects of the present disclosure.

FIG. 5A and FIG. 5B are schematic drawings that illustrate non-limiting example embodiments of an end-to-end multi-task learning framework suitable for use with embodiments of the present disclosure.

FIG. 6 is a flowchart that illustrates a non-limiting example embodiment of a method of providing biomechanical analyses of movements of subjects according to various aspects of the present disclosure.

FIG. 7 is a block diagram that illustrates a non-limiting example embodiment of a computing device appropriate for use as a computing device with embodiments of the present disclosure.

### DETAILED DESCRIPTION

The United States alone has more than 150,000 workers suffering from back injuries annually due to repetitive lifting of heavy objects using inappropriate postures. An ergonomic risk score can be determined by observing how a subject is performing such a task, and high ergonomic risk scores can be used to retrain the subject to perform the task in a less-risky way.

The most widely used methods in the industry for determining ergonomic risk scores are Rapid Entire Body Assessment (REBA) and European Assembly Work-sheet (EAWS). REBA provides a risk score between 1-15 by considering all the main body joint angles, magnitude of applied force, and ease of grasping an object. However, in practice, the quantification of these values is mostly based on observations. EAWS is a similar method that focuses on observation of upper extremity postures in assembly tasks. It is desirable to develop automated techniques for performing such risk assessments.

The present disclosure is inspired by the importance of HPA problems and their significant impact on the health and safety of industrial workers. However, our approach is not limited to this specific application and it is a novel design that can benefit other aspects of HAE research. We leverage from consistent representation of human 3D poses and propose an end-to-end multi-task framework that solves Human Action Detection (HAD) as an auxiliary task to improve the HPA performance. Skeleton-based methods have been shown to provide the opportunity of developing more generalizable algorithms for various applications in Human Action Recognition (HAR) and prediction problems. However, they have not been leveraged enough in HAE.

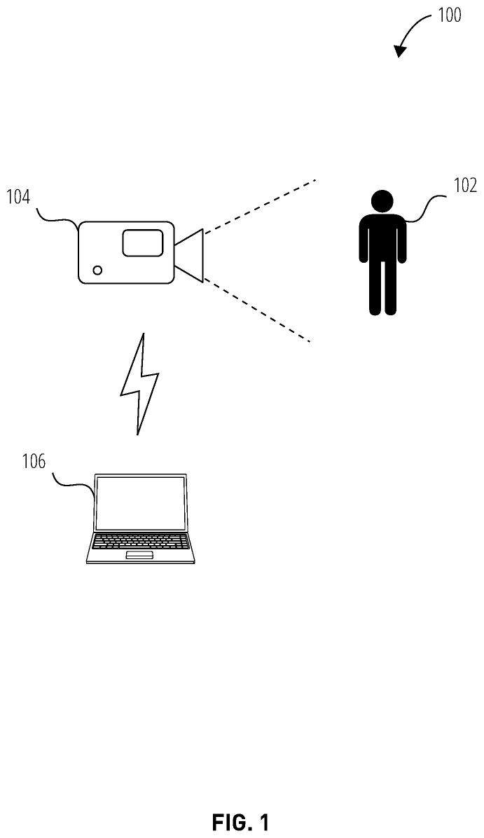

FIG. 1 is a schematic illustration of a non-limiting example embodiment of a system for automated monitoring of biomechanical postural assessment according to various aspects of the present disclosure. In the system 100, one or more cameras 104 are used to monitor a plurality of actions performed by a subject 102. The cameras 104 transmit video data to a biometric analysis computing device 106, which analyzes the video data in order to provide assessments of the subject 102 while the subject 102 was performing the plurality of actions.

In some embodiments, any type of cameras 104 may be used. For example, in some embodiments, a single visible light camera 104 may be used. In other embodiments, multiple visible light cameras 104 may be used to capture video data of the subject 102 from different angles. In some embodiments, different types of cameras, including but not limited to infrared cameras, time-of-flight sensors, depth sensors, LIDAR sensors, or other types of devices may be used as cameras 104 to capture data of the subject 102 while performing the plurality of actions. The plurality of actions may be any type of action, including but not limited to repetitive lifting tasks.

In some embodiments, the biometric analysis computing device 106 may be configured to create three-dimensional joint location data based on captured video data using any suitable known technique. This three-dimensional joint location data is a form of structured data. The biometric analysis computing device 106 then uses the three-dimensional joint location data to measure ergonomics risk.

In ergonomic risk assessment, posture alone cannot accurately determine the risk level. The activity class contains information that is key to measure ergonomics risk for a particular activity. Accordingly, the present disclosure treats human postural assessment as a multi-task learning problem that includes an activity detection task and a postural assessment task. This work brings together action detection and quality assessment using a novel multi-task learning framework. In some embodiments, the framework used comprises a Graph Convolutional Network (GCN) backbone and an Encoder-Decoder Temporal Convolutional Network (ED-TCN) for action detection and a Long-Short-Term-Memory (LSTM)-based model for activity assessment.

The contribution of the present disclosure is at least threefold. (1) We introduce a novel combination of GCN with ED-TCN for action detection in long videos that outperforms state-of-the art results as tested on the UW-IOM dataset. (2) Our Multi-Task Learning (MTL)-emb method initiates a line of research for more informed activity assessment by fusing activity embedding with spatial features for Ergonomics Risk Assessment (ERA). (3) We present a way to use the skeletal information for activity assessment in a Multi-Task Learning (MTL) framework that may enable generalization across a variety of environments and leverage anthropometric information.

Action Detection (AD) is the task of detecting activities and localizing their start and end times (or start frame and end frame, or start time step and end time step, or any other suitable measurement of the start and end of the activities) within video data. Human postural assessment (HPA) considers the task of finding the ergonomics risk score corresponding to the human posture at every frame of a video. To the best of our knowledge, this is the first work that combines the two separately studied problems of AD and HPA in a multi-task setting. Moreover, the combination of the GCN backbone with a powerful ED-TCN structure for Single-Task Learning-based AD (STL-AD) is a novel idea that can compete with methods using image-based features (if the actions are not too similar). The Postural Assessment (PA) branch also offers a new combination of GCN along with a LSTM unit to learn the relation between human joint dynamics and the corresponding ergonomics risk score.

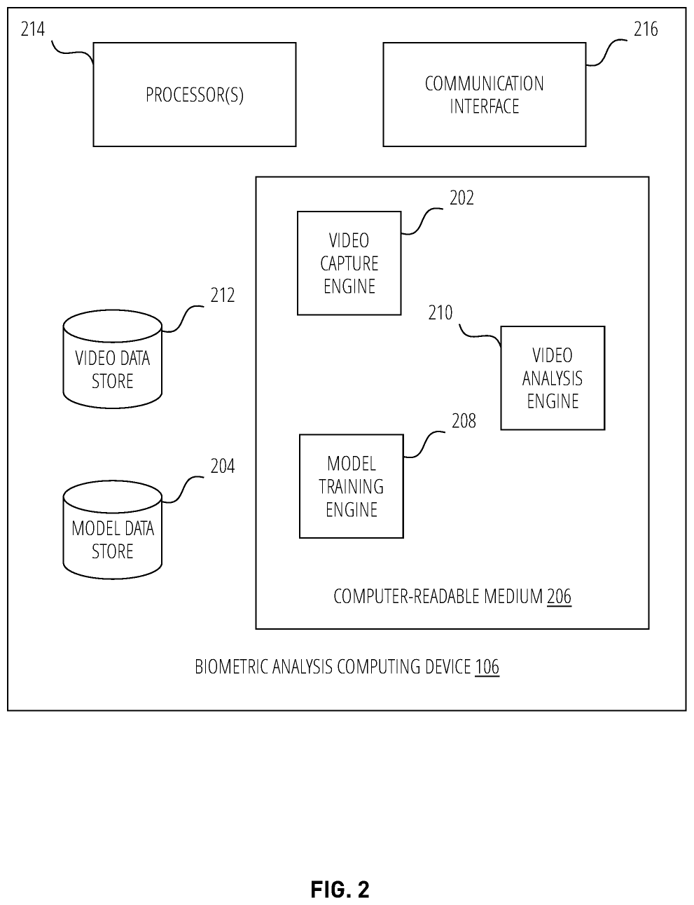

FIG. 2 is a block diagram that illustrates a non-limiting example embodiment of a biometric analysis computing device according to various aspects of the present disclosure. The biometric analysis computing device 106 illustrated in FIG. 1 is a laptop computing device. In other embodiments, the biometric analysis computing device 106 may be a desktop computing device, a server computing device, a mobile computing device, or a computing device of a cloud computing system. Though a single biometric analysis computing device 106 is illustrated for clarity, in some embodiments, the functionality of the biometric analysis computing device 106 may be provided by a plurality of computing devices working together and connected by a network.

As shown, the biometric analysis computing device 106 includes one or more processors 214, a communication interface 216, a computer-readable medium 206, a video data store 212, and a model data store 204.

In some embodiments, the processors 214 include any suitable type of general-purpose computer processor. In some embodiments, the processors 214 may include one or more special-purpose computer processors or AI accelerators optimized for specific computing tasks, including but not limited to graphical processing units (GPUs), vision processing units (VPUs), and tensor processing units (TPUs). In some embodiments, the communication interface 216 includes hardware and/or software suitable for communication with the cameras 104 via one or more of any wired (including but not limited to one or more of Ethernet, USB, and FireWire) or wireless (including but not limited to one or more of Wi-Fi, WiMAX, 4G, 5G, and Bluetooth) technologies.

As shown, the computer-readable medium 206 has stored thereon computer-executable instructions that, in response to execution by the processors 214, cause the biometric analysis computing device 106 to provide a video capture engine 202, a model training engine 208, and a video analysis engine 210. In some embodiments, the video capture engine 202 is configured to receive video data from the cameras 104 and store the video data in the video data store 212. In some embodiments, the video capture engine 202 may also be configured to generate an interface or otherwise ingest information to label actions depicted in the video data with a start time, an end time, and a postural assessment score in order to serve as the basis for training data. In some embodiments, the model training engine 208 is configured to use labeled video data from the video data store 212 to train one or more machine learning models to identify activities in video data and to determine postural assessment scores for each activity, and to store the trained machine learning models in the model data store 204. In some embodiments, the video analysis engine 210 is configured to use the trained machine learning models from the model data store 204 to identify activities in video data received from the cameras 104 and to determine postural assessment scores for each such activity. Further details of the configuration of each of these engines are provided below.

As used herein, “engine” refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

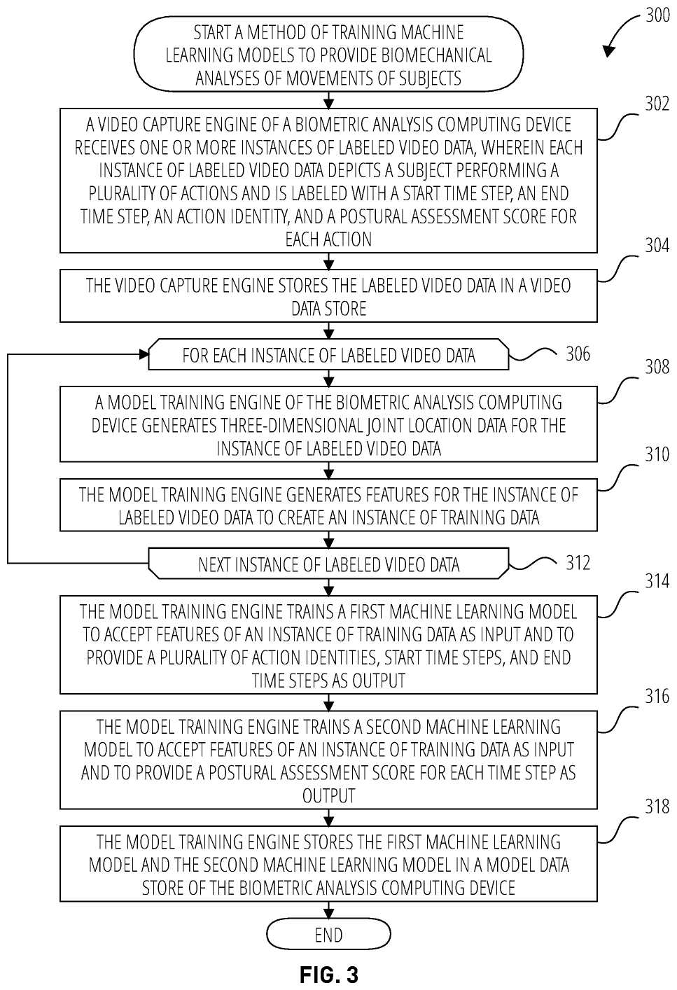

FIG. 3 is a flowchart that illustrates a non-limiting example embodiment of a method of training machine learning models to provide biomechanical analyses of movements of subjects according to various aspects of the present disclosure.

From a start block, the method 300 proceeds to block 302, where a video capture engine 202 of a biometric analysis computing device 106 receives one or more instances of labeled video data, wherein each instance of labeled video data depicts a subject 102 performing a plurality of actions and is labeled with a start time step, an end time step, an action identity, and a postural assessment score for each action. In some embodiments, each time step in the labeled video data may correspond to a frame of the video data. In some embodiments, the time steps may be represented by time codes, elapsed times, or via any other suitable technique. In some embodiments, the action identities describe a type of action being performed by the subject 102 (e.g., bend, walk, stand, stand-and-reach, box-bend-and-pick-up-low, box-stand-and-pick-up-mid, box-walk-hold, etc.). In some embodiments, the labels may be received via an interface generated by the video capture engine 202, and may be provided by a user reviewing the video data. In some embodiments, the labeled video data may be retrieved from a known dataset, such as the UW-IOM dataset or the TUM dataset.

In block 304, the video capture engine 202 stores the labeled video data in a video data store 212. The method 300 then proceeds to a for-loop defined between a for-loop start block 306 and a for-loop end block 312 wherein each instance of labeled video data is processed to generate features.

From for-loop start block 306, the method 300 proceeds to block 308, where a model training engine 208 of the biometric analysis computing device 106 generates three-dimensional joint location data for the instance of labeled video data. Multiple techniques for generating three-dimensional joint location data based on video data received from cameras 104 (including one or more of visible light cameras, depth cameras, etc.) are known to those of skill in the art, and so are not described in detail herein. In some embodiments, the labeled video data may already include three-dimensional joint location data when received by the video capture engine 202 and stored in the video data store 212.

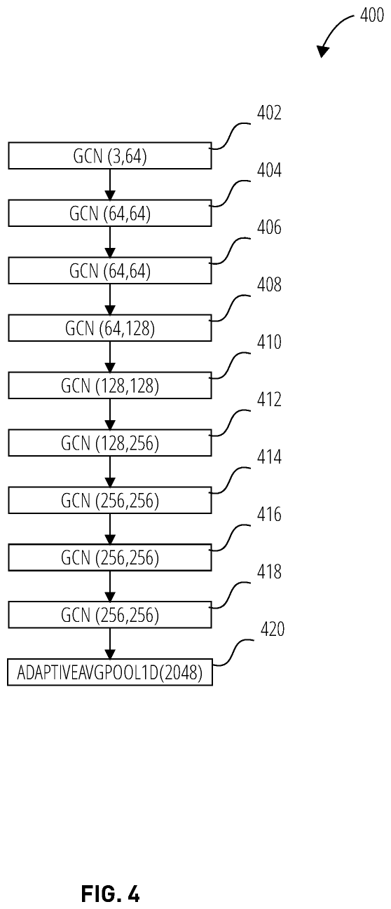

In block 310, the model training engine generates features for the instance of labeled video data to create an instance of training data. Any suitable technique for generating features may be used. FIG. 4 illustrates a non-limiting example embodiment of a feature generation backbone suitable for use at block 310, and is described in further detail below. In some embodiments, the generated features may be stored in the video data store 212 along with the instance of labeled video data.

The method 300 then proceeds to the for-loop end block 312. If further instances of labeled video data remain to be processed, then the method 300 returns to the for-loop start block 306 to process the next instance of labeled video data. Otherwise, the method 300 proceeds to block 314.

At block 314, the model training engine 208 trains a first machine learning model to accept features of an instance of training data as input and to provide a plurality of action identities, start time steps, and end time steps as output. At block 316, the model training engine 208 trains a second machine learning model to accept features of an instance of training data as input and to provide a postural assessment score for each time step as output.

In the human action detection problem addressed by the first machine learning model, the task is to identify the activities that are happening in untrimmed videos and determine the corresponding initial and final frames. A popular approach that is inspired by works in audio generation and speech recognition is to use feed-forward (i.e., non-recurrent) networks for modeling long sequences. The main component of these methods is a 1D dilated causal convolution that can model long-term dependencies.

A dilated convolution is a filter that applies to an area larger than its length by skipping input values by a certain length. A causal convolution is a 1D convolution which ensures the model does not violate the ordering of the input sequence. The prediction emitted by a causal convolution (that is, p(x₁|x₁, . . . , xₜ₋₁)) at time step t only depends on the previous data. Combining these two properties, dilated causal convolutions have large receptive fields and are faster than Recurrent Neural Networks (RNNs). Moreover, they are shallower than regular causal convolution due to dilation.

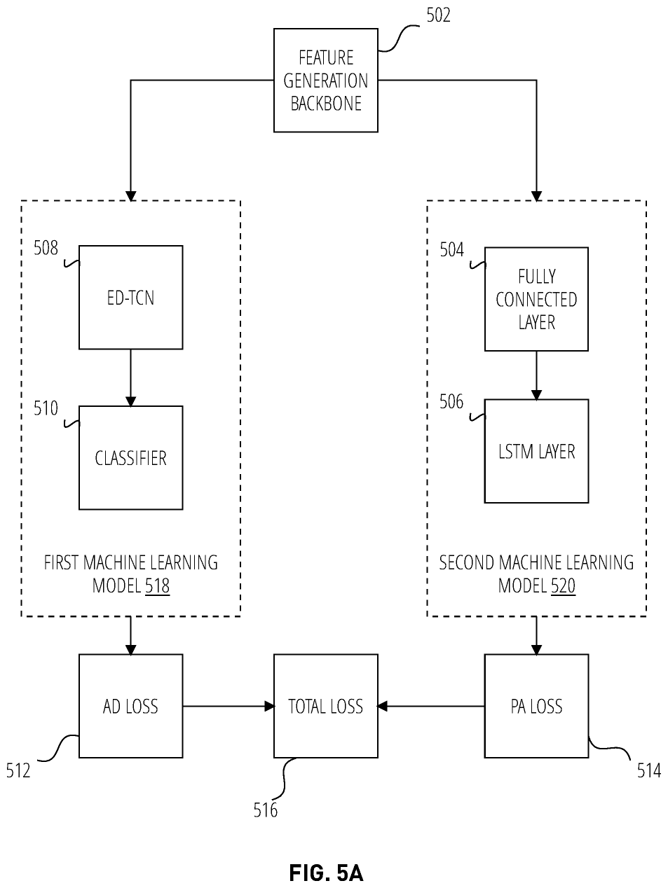

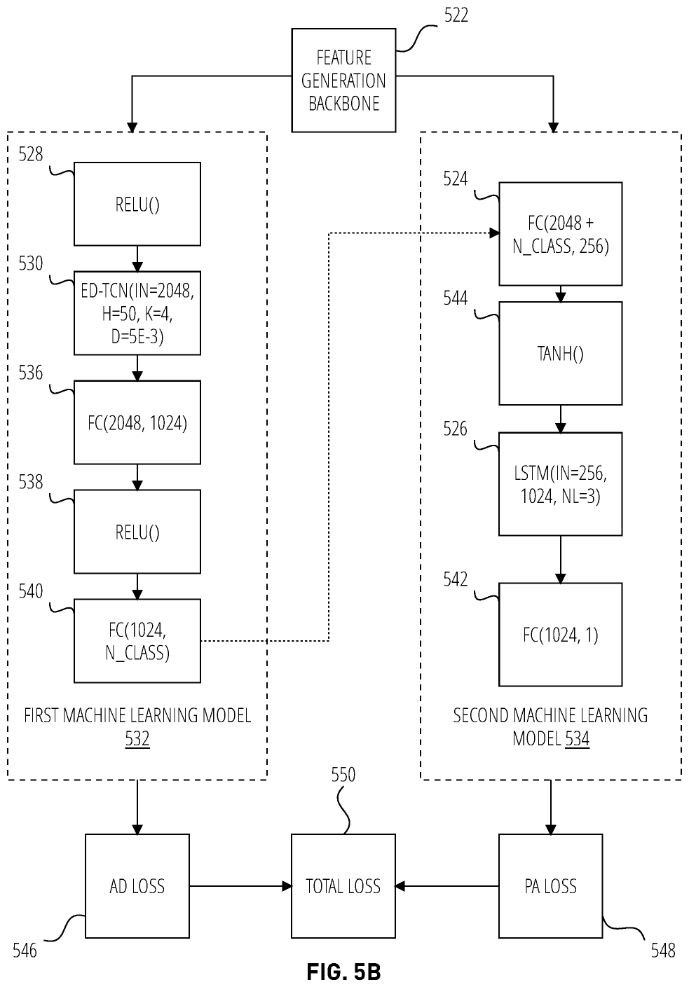

Accordingly, for the first machine learning model, some embodiments of the present disclosure use an ED-TCN-based on 1D dilated convolutions. Our design consists of a hierarchy of four temporal convolutions, pooling, and upsampling layers. The output of the ED-TCN followed by a Fully Connected (FC) layer and a ReLU activation is fed to the classification layer. In FIG. 5A, a non-limiting example embodiment is illustrated wherein the output of the feature generation backbone 502 is provided to a first machine learning model 518, where the first machine learning model 518 includes an encoder-decoder temporal convolutional network 508 and a classifier 510. In FIG. 5B, another non-limiting example embodiment is illustrated. In FIG. 5B, the output of the feature generation backbone 522 is provided to a first machine learning model 532 that includes a ReLU layer 528, an ED-TCN 530, a fully connected layer 536, another ReLU layer 538, and a classifier 540.

In using ED-TCN for activity detection, the focus is on learning the temporal sequence and localizing activities. It is common to extract spatial features prior to training from an independent network like VGG16 or ResNet. Our proposed framework learns the spatial and temporal properties of the data in an end-to-end fashion. To our knowledge, this is the first attempt to use ED-TCN in an end-to-end architecture with a spatial feature detector. In addition, the combination of GCN with ED-TCN for solving activity detection is a novel approach and it shows promising results.

Regarding the human postural assessment (HPA) problem addressed by the second machine learning model, we define HPA as a sub-category of human action evaluation (HAE) where the activity score is determined based on the safety of the posture. In HPA, the task is to find a mapping between the spatio-temporal features and ergonomics risk score. Our proposed regressor uses the shared spatial features coming from the GCN backbone. The GCN features go through a fully connected layer with ReLU nonlinearity and are then fed into a stacked LSTM structure to predict postural assessment scores such as REBA scores. In FIG. 5A, a non-limiting example embodiment is illustrated wherein the output of the feature generation backbone 502 is provided to a second machine learning model 520 that includes a fully connected layer 504 and a long short-term memory layer 506. In FIG. 5B, a non-limiting example embodiment is illustrated wherein the output of the feature generation backbone 522 is provided to a second machine learning model 534 that includes a fully connected layer 524, a tanh activation layer 544, a long short-term memory layer 526, and a fully connected layer 542. The fully connected layer 524 may optionally receive an output of the first machine learning model 532, including but not limited to a softmax output of the classifier 540, as an additional input.

Regarding the total loss of the first machine learning model and the second machine learning model, multi-task learning (MTL) is a popular framework for end-to-end training of a single network for solving multiple related tasks. In these networks, a common backbone provides the data representation for branches responsible for learning a specific task. Usually in MTL, there is a main task plus multiple auxiliary tasks that complement the core task. For instance, in HAE, the main task is to determine the action quality. However, action quality is not independent of what action is carried out, hence action detection is appropriate to be chosen as the auxiliary task.

The supervision signals from the auxiliary tasks can be viewed as inductive biases that limit the hypothesis search space and result in a more generalizable solution. In our work, the main task is to predict the postural assessment scores. However, the information about human action is closely related to its corresponding ergonomics risk. Therefore, the auxiliary task in this case is the action detection. Long duration videos (e.g., videos that include a plurality of actions instead of only a single action) pose an additional challenge since, unlike most of the HAE datasets, both the activities and their risk scores vary over time. Therefore, in any video, activity localization and the ERA task involves predicting a smooth function that shows how the risk is changing throughout the video.

We studied two different architectures for solving this MTL problem. In the first architecture, the heads corresponding to each task only share the GCN-driven features. In the second architecture, the output of the softmax layer of the action detection head is fused to the feature going to the LSTM regressor (illustrated as the dashed line between the classifier 540 and the fully connected layer 524 in FIG. 5B.

We consider a weighted average of the AD loss and the PA loss as the overall total loss (shown in FIG. 5A as activity detection loss 512, postural assessment loss 514, and total loss 516; and shown in FIG. 5B as activity detection loss 546, postural assessment loss 548, and total loss 550). The total loss may be represented by the loss function,

$${P A}_{} = {\sum }_{t = 1}^{T} {α ( {x}_{t} - {y}_{t} )}^{2} + β \vert {x}_{t} - {y}_{t} \vert$$

where yₜ is the frame-wise ground truth postural assessment score and xₜ is the model prediction. α and β are weights to be learned. For activity detection, we use cross-entropy loss between ground truth and model prediction,

$${A D}_{} = - {\sum }_{t = 1}^{T} {{\sum }^{Cl}}_{c = 1} {y}_{t , c} log ( {x}_{t , c} )$$

where Cl is the number of classes. The overall loss is the sum of all the losses,

[symbol]

_{MTL}= [symbol] _{PA}+γ [symbol] _{AD}

where γ is to be learned. Any suitable optimization technique can be used to train the machine learning models. In some embodiments, the Adam optimizer may be used for training.

Returning to FIG. 3, at block 318, the model training engine 208 stores the first machine learning model and the second machine learning model in a model data store 204 of the biometric analysis computing device 106. The method 300 then proceeds to an end block and terminates.

FIG. 4 is a schematic drawing that illustrates a non-limiting example embodiment of a backbone for spatial feature extraction according to various aspects of the present disclosure. Since graph convolutional networks, or GCNs, are known to be powerful in representing structured data, this feature generation backbone 400 uses a sequence of stacked GCN layers 402-418 as the backbone for spatial feature extraction. GCNs were developed to process data belonging to non-Euclidean spaces. GCNs are a good choice for representing human body kinematics since the commonly used independent and identically distributed random variable assumption is not applicable. Spatio-Temporal Graph Convolutional Networks (ST-GCN) introduced a powerful tool for analyzing human motions in videos, and has been utilized in several computer vision applications. However, most of these works focus on solving Human Action Recognition (HAR) problems. In this work, we leverage a GCN backbone to learn the joint embedding and use that to directly predict the ergonomics risks rather than solving it as a separate problem.

Given the input xϵR^{D×N}, where D is equal to 3 as the joints are represented using (x, y, z) coordinates and N is the number of joints, the adjacency matrix AϵR^{N×N}, and the degree matrix \hat{D} with Dᵢᵢ=ΣⱼAᵢⱼ, a Graph Convolution (GC) can be written as:

$$f = {\hat{D}}^{- \frac{1}{2}} \hat{A} {\hat{D}}^{- \frac{1}{2}} {x}^{T} W$$

Here, Â=A≠I, I is the identity matrix. For a graph with human skeletal structure, A is designed based on the anatomical connections among the joints. WϵR^{D×F} is the weight matrix that is to be learned. Hence, if the input to a GCN layer is D×N, the output feature f is N×F, where F is the chosen output feature size. In some embodiments of the feature generation backbone 400, each GCN is followed by a ReLU activation (not illustrated). Moreover, the adjacency matrix may be partitioned into three sub-matrices to better capture the spatial relations among the joints. Therefore, the equation above may be written in a summation form for each GCN layer as:

$$f = {\sum }_{a = 1}^{3} {\hat{D}}_{a}^{- \frac{1}{2}} {A}_{a} {\hat{D}}_{a}^{- \frac{1}{2}} {x}^{T} {W}_{a}$$

where a indexes each partition.

In the illustrated embodiment, the output of the last GCN layer 418 is provided to an average pooling layer 420 that computes a size of stride, kernel, and padding base on the input size, and then applies a 1D average pooling over the input signal composed of several input planes. In some embodiments, the AdaptaveAvgPoolID from Pytorch may be suitable for use in the average pooling layer 420.

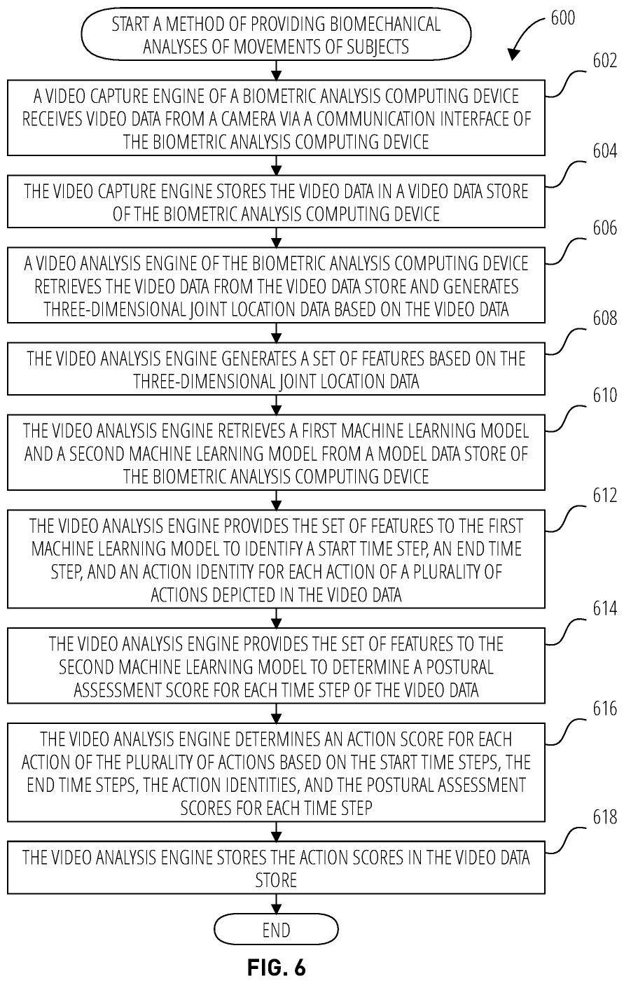

FIG. 6 is a flowchart that illustrates a non-limiting example embodiment of a method of providing biomechanical analyses of movements of subjects according to various aspects of the present disclosure. The method 600 uses machine learning models trained by the method 300 described above to process video data and generate postural assessment scores for activities identified therein.

From a start block, the method 600 proceeds to block 602, where a video capture engine 202 of a biometric analysis computing device 106 receives video data from one or more cameras 104 via a communication interface 216 of the biometric analysis computing device 106. The video data may be received via any suitable communication technology, as discussed above.

At block 604, the video capture engine 202 stores the video data in a video data store 212 of the biometric analysis computing device 106. At block 606, a video analysis engine 210 of the biometric analysis computing device 106 retrieves the video data from the video data store 212 and generates three-dimensional joint location data based on the video data. As discussed above during the description of the method 300 of training, the three-dimensional joint location data may be generated using any suitable technique. In some embodiments, instead of receiving video data from one or more cameras 104, the video capture engine 202 may directly receive three-dimensional joint location data, in which case the method 600 may start at block 608.

At block 608, the video analysis engine 210 generates a set of features based on the three-dimensional joint location data. Any suitable technique for generating the set of features may be used that corresponds to the technique that was used for generating the sets of features for training the machine learning models, including but not limited to using the feature generation backbone 400 illustrated in FIG. 4 and discussed above.

At block 610, the video analysis engine 210 retrieves a first machine learning model and a second machine learning model from a model data store 204 of the biometric analysis computing device 106. The first machine learning model may be the first machine learning model 518, the first machine learning model 532, or any other machine learning model trained to identify actions from features generated based on three-dimensional joint location data. The second machine learning model may be the second machine learning model 520, the second machine learning model 534, or any other machine learning model trained to predict postural assessment scores from features generated based on three-dimensional joint location data.

At block 612, the video analysis engine 210 provides the set of features to the first machine learning model to identify a start time step, an end time step, and an action identity for each action of a plurality of actions depicted in the video data, and in block 614, the video analysis engine 210 provides the set of features to the second machine learning model to determine a postural assessment score for each time step of the video data.

At block 616, the video analysis engine 210 determines an action score for each action of the plurality of actions based on the start time steps, the end time steps, the action identities, and the postural assessment scores for each time step. The video analysis engine 210 may use the postural assessment scores for each time step to determine action scores for each action using any suitable technique. For example, the video analysis engine 210 may determine a mean postural assessment score, a median postural assessment score, a mode postural assessment score, a minimum postural assessment score, or a maximum postural assessment score for the time steps between the start time step and the end time step for each action to determine the action score for each action.

At block 618, the video analysis engine 210 stores the action scores in the video data store 212. The method 600 then proceeds to an end block and terminates. Though the method 600 is described as ending at this point, in some embodiments, the method 600 may continue to use the stored actions scores for any purpose. For example, in some embodiments the video analysis engine 210 may detect action scores that are above or below an alert threshold, and may generate alerts to warn a subject that they are performing ergonomically risky actions and may be hurt if they continue. As another example, in some embodiments the video analysis engine 210 may generate graphs, charts, or other reports that show actions scores for a subject (or a group of subjects) over time, such that a training level of the subject (or group of subjects) may be monitored and safe practices can be encouraged when it is determined that they are not being adhered to.

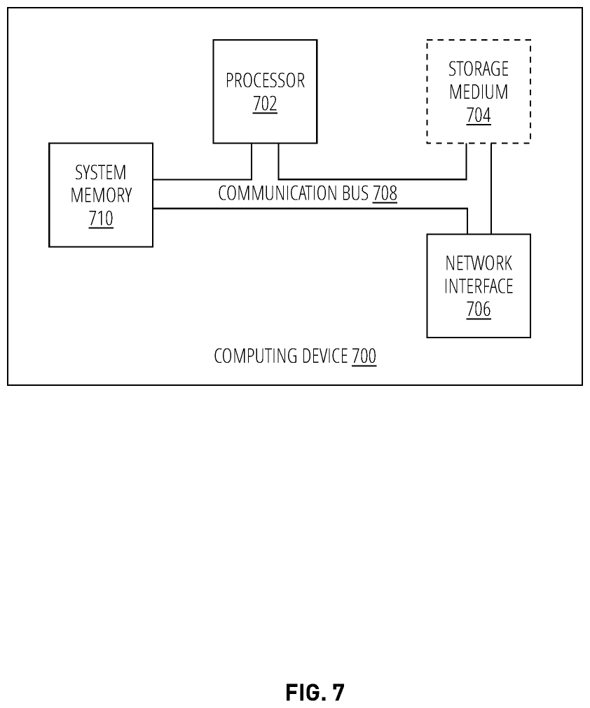

FIG. 7 is a block diagram that illustrates aspects of an exemplary computing device 700 appropriate for use as a computing device of the present disclosure. While multiple different types of computing devices were discussed above, the exemplary computing device 700 describes various elements that are common to many different types of computing devices. While FIG. 7 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Some embodiments of a computing device may be implemented in or may include an application-specific integrated circuit (ASIC), a field-programmable gate array (FPGA), or other customized device. Moreover, those of ordinary skill in the art and others will recognize that the computing device 700 may be any one of any number of currently available or yet to be developed devices.

In its most basic configuration, the computing device 700 includes at least one processor 702 and a system memory 710 connected by a communication bus 708. Depending on the exact configuration and type of device, the system memory 710 may be volatile or nonvolatile memory, such as read only memory (“ROM”), random access memory (“RAM”), EEPROM, flash memory, or similar memory technology. Those of ordinary skill in the art and others will recognize that system memory 710 typically stores data and/or program modules that are immediately accessible to and/or currently being operated on by the processor 702. In this regard, the processor 702 may serve as a computational center of the computing device 700 by supporting the execution of instructions.

As further illustrated in FIG. 7, the computing device 700 may include a network interface 706 comprising one or more components for communicating with other devices over a network. Embodiments of the present disclosure may access basic services that utilize the network interface 706 to perform communications using common network protocols. The network interface 706 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 706 illustrated in FIG. 7 may represent one or more wireless interfaces or physical communication interfaces described and illustrated above with respect to particular components of the computing device 700.

In the exemplary embodiment depicted in FIG. 7, the computing device 700 also includes a storage medium 704. However, services may be accessed using a computing device that does not include means for persisting data to a local storage medium. Therefore, the storage medium 704 depicted in FIG. 7 is represented with a dashed line to indicate that the storage medium 704 is optional. In any event, the storage medium 704 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 702, system memory 710, communication bus 708, storage medium 704, and network interface 706 are known and commercially available. For ease of illustration and because it is not important for an understanding of the claimed subject matter, FIG. 7 does not show some of the typical components of many computing devices. In this regard, the computing device 700 may include input devices, such as a keyboard, keypad, mouse, microphone, touch input device, touch screen, tablet, and/or the like. Such input devices may be coupled to the computing device 700 by wired or wireless connections including RF, infrared, serial, parallel, Bluetooth, Bluetooth low energy, USB, or other suitable connections protocols using wireless or physical connections. Similarly, the computing device 700 may also include output devices such as a display, speakers, printer, etc. Since these devices are well known in the art, they are not illustrated or described further herein.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system, comprising:
a computing system including at least one computing device; and
a camera communicatively coupled to the computing system via a network;
wherein the computing system is configured to:
generate a set of features based on three-dimensional joint location data representing postures of a subject over a plurality of time steps depicted in video data captured by the camera;
provide the set of features to a first machine learning model trained to identify a start time step, an end time step, and an action identity for each action of the plurality of actions;
provide the set of features to a second machine learning model trained to determine a postural assessment score for each time step; and
determine an action score for each action of the plurality of actions based on the start time steps, the end time steps, the action identities, and the postural assessment scores for each time step.

2. The system of claim 1, wherein the computing system is further configured to:
receive the video data from the camera; and
generate the three-dimensional joint location data based on the video data.

3. The system of claim 2, wherein each time step of the plurality of time steps is represented by a frame of the video data.

4. The system of claim 3, wherein the first machine learning model includes an encoder-decoder temporal convolutional network.

5. The system of claim 3, wherein the second machine learning model includes a stacked long short-term memory model.

6. The system of claim 1, wherein generating the set of features based on the three-dimensional joint location data includes providing the three-dimensional joint location data to a sequence of stacked graph convolutional networks.

7. The system of claim 1, wherein the computing system is further configured to:
receive a set of training data, wherein each instance of training data in the set of training data is labeled with a plurality of training activities that each take place over a series of time steps, and wherein each training activity of the plurality of training activities is labeled with a postural assessment score.

8. The system of claim 7, wherein the computing system is further configured to:
train the first machine learning model and the second machine learning model using the set of training data.

9. A computer-implemented method of providing biomechanical analyses of movements of a subject, the method comprising:
generating, by a computing device, a set of features based on three-dimensional joint location data representing positions of the subject over a plurality of time steps while performing a plurality of actions;
providing, by the computing device, the set of features to a first machine learning model trained to identify a start time step, an end time step, and an action identity for each action of the plurality of actions;
providing, by the computing device, the set of features to a second machine learning model trained to determine a postural assessment score for each time step; and
determining, by the computing device, an action score for each action of the plurality of actions based on the start time steps, the end time steps, the action identities, and the postural assessment scores for each time step.

10. The computer-implemented method of claim 9, wherein providing the set of features to the first machine learning model includes providing the set of features to an encoder-decoder temporal convolutional network.

11. The computer-implemented method of claim 10, wherein providing the set of features to the second machine learning model includes providing the set of features and the action identities to a stacked long short-term memory (LSTM) model to generate the postural assessment scores.

12. The computer-implemented method of claim 9, further comprising:
receiving, by the computing device, video data representing the movements of the subject while performing the plurality of actions; and
generating, by the computing device, the three-dimensional joint location data based on the video data.

13. The computer-implemented method of claim 12, wherein each time step of the plurality of time steps is represented by a frame of the video data.

14. The computer-implemented method of claim 13, wherein providing the set of features to the second machine learning model includes providing the set of features to a stacked long short-term memory (LSTM) model to obtain the postural assessment scores.

15. The computer-implemented method of claim 9, wherein generating the set of features based on the three-dimensional joint location data includes providing the three-dimensional joint location data to a sequence of stacked graph convolutional networks.

16. A computer-implemented method of training machine learning models to provide biomechanical analyses of movements of subjects, the method comprising:
receiving, by a computing device, a set of training data, wherein each instance of training data in the set of training data is labeled with a plurality of activities that each take place over a series of time steps, and wherein each activity of the plurality of activities is labeled with a postural assessment score;
generating, by the computing device, features for each instance of training data;
training, by the computing device, a first machine learning model to accept features of an instance of training data as input and to provide a plurality of action identities, start time steps, and end time steps as output;
training, by the computing device, a second machine learning model to accept features of an instance of training data as input and to provide a postural assessment score as output for each time step; and
storing, by the computing device, the first machine learning model and the second machine learning model in a model data store for processing new data.

17. The computer-implemented method of claim 16, wherein each instance of training data is a video of a subject, and wherein the method further comprises generating three-dimensional joint location data based on the video of the subject.

18. The computer-implemented method of claim 17, wherein generating the features for each instance of training data includes providing the three-dimensional joint location data to a sequence of stacked graph convolutional networks.

19. The computer-implemented method of claim 17, wherein training the first machine learning model includes training an encoder-decoder temporal convolutional network.

20. The computer-implemented method of claim 17, wherein training the second machine learning model includes training a stacked long short-term memory structure to provide postural assessment scores.
